(19) United States
(12) Patent Application Publication
(10) Pub. No.: US 2012/0163775 A1
(43) Pub. Date: Jun. 28, 2012

(54) Image system

(76) Inventor: Pooja Banerjee, Dallas, TX (US)

(21) Appl. No.: 12/979,558

(22) Filed: Dec. 28, 2010

(51) Int. Cl. H04N 5/93

(52) U.S. Cl. 386/280; 386/278; 386/E05.028

(57) ABSTRACT

A video system for processing video images may include an acquisition station to review the video images and forming a video clip based upon the video images. The acquisition station may edit the video clip, and the acquisition station may compress the edited video clip. The receiving station may receive the compressed and edited video clip.

### FIELD OF THE INVENTION

The present invention relates generally to image processing and, in particular, to a distributed architecture that allows for edited digital video clips which may be compressed to be transported to remote locations.

### BACKGROUND

Traditionally, image processing systems especially for medical uses have been film-based. Film based images involves obtaining images on film. The films can then be reviewed using a light box. More recently, digital image processing has been gaining acceptance. In digital image processing, images are acquired digitally and can be displayed on an electronic monitor.

A number of advantages associated with digital imaging have been recognized. First, digital imaging provides substantially real-time images. In some cases, follow-up views may be acquired based on real-time review of the digital images such that a return visit by the patient can be avoided. In addition, digital processing allows for image enhancement. In this regard, a physician may zoom in on an area of interest, adjust the image contrast or brightness or otherwise manipulate the image after acquisition. Moreover, it is sometimes possible to obtain improved diagnostic information by digital processing. For example, a digital image that is identified as being suspicious or is otherwise of interest can be exported to certain CAD systems that perform digital analyses. For example, such CAD systems may perform a pixel-by-pixel analysis of the digital image to identify areas of reduced intensity that may be missed upon review of the images using the naked eye. Such areas may indicate conditions of interest that the physician may desire to review more closely, such as by zooming in on that region of the image or otherwise enhancing the image.

Despite these advantages, certain perceived disadvantages have slowed the process of full digital acceptance. Some of the perceived disadvantages are specific to particular digital imaging equipment. In this regard, some current digital imaging systems do not provide a full field of view for a patient's breast. As a result, multiple images may be required for a screening analysis or the digital imaging system may be relegated to follow-up imaging of an area identified by film. In addition, sonic current digital imaging systems provide a limited resolution that may be deemed insufficient for certain applications. However, full field, high-resolution digital imaging systems are now being marketed, including the SenoScan system of Fischer Imaging Corp. of Thornton, Colo.

Other perceived disadvantages relate to operational restrictions of conventional digital systems. Many conventional digital systems are stand alone units that include the image acquisition equipment or gantry (e.g., the x-ray tube, compression paddles, detector and the like), a processor executing image processing logic and a display terminal that may include oversized high resolution monitors. In these cases, a physician may review images at the physical equipment site. This may tie up the equipment when needed, thereby reducing patient throughput or require that the physician plan around a schedule for accessing the equipment.

Moreover, the images available for review at the equipment may be limited. In this regard, physicians may desire to compare current images for a patient to images obtained for that patient at an earlier date, perhaps obtained using different equipment. Physicians may otherwise desire to review images obtained for multiple patients at different image acquisition sites, e.g., in connection with a large medical facility. In such cases, the images desired for a particular review session may not be readily available at the equipment site. Additionally, certain tools such as CAD processing or other diagnostic tools may not be available at each site where patient images reside.

Additional disadvantages of medical imaging files may include a large file size of the medical imaging files created on the DICOM imaging systems. Additionally, these systems may not be able to incorporate imaging and text pictures or other files and the systems may not be able to annotate using symbols, text or audio files.

The following patents are incorporated by reference in their entirety.

U.S. Pat. No. 7,639,780 discloses a distributed architecture allowing for the decoupling of mammographic image acquisition and review, thereby enabling more efficient use of resources and enhanced processing.

U.S. Pat. No. 7,426,567 discloses a method and apparatus for streaming DICOM images or objects through data element sources and sinks.

### SUMMARY

A video system for processing video images may include an acquisition station to review the video images and forming a video clip based upon the video images. The acquisition station may edit the video clip, and the acquisition station may compress the edited video clip. The receiving station may receive the compressed and edited video clip.

The acquisition station may edit the video clip in accordance with Dicom, and the acquisition station may edit the header of the video clip.

The acquisition station may merge at least two video images to be edited into a single video clip, and the acquisition station may edit out a frame from the video images.

The acquisition station may edit to add special effects to the video clip, and the acquisition station may export the video clip to a mobile device.

The acquisition station may upload the video clips to a paid video sharing site, and the acquisition station may upload the video clip to the Internet.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a imaging system of the present invention;

FIG. 2 illustrates an acquisition system of the imaging system of the present invention;

FIG. 3 illustrates the steps of the method of the present invention.

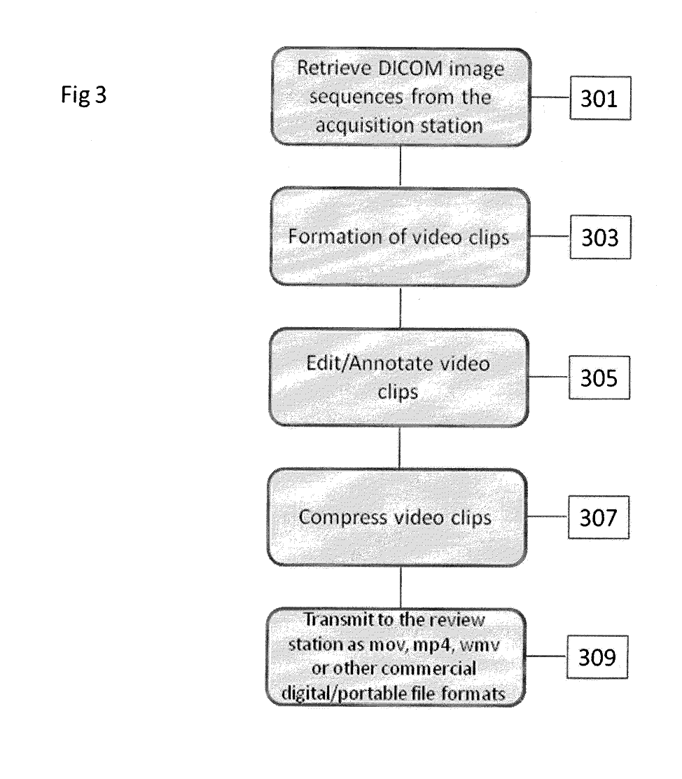

### DETAILED DESCRIPTION

The present invention generates video clips including medical and educational content from larger files. Video clips are short clips of video, usually part of a longer piece. The term is also more loosely used to mean any short video less than the length of a traditional television program. More specifically, the present invention may convert digital cine-angiographic procedural files into digitally compacted and edited video clips and may generate web-compatible distance learning products for health care from the video clips, pharmaceutical, medical device, educational and biotechnology organizations.

The video clips of the present invention provides a full range of applications include but not limited to presentations, viewing DICOM images and runs, electronic sharing, medical consultations, distant learning, telemedicifle, providing practice and daily medical practice, and benefiting the medical device industry.

The video clips of the present invention may be used by patients and the general population and may be used with electronic medical records such as digital clips which may be attached to notes/letters.

The present invention achieves compacting medical angiographic and other procedure recordings into digitally compacted and edited web transmission compatible video clips.

The present invention creates a conversion pathway of large sized digital files to convert into significantly smaller video clips to facilitate distant learning of specialized procedural skills for physicians, technicians and allied medical personnel.
The present invention utilizes the digitally compacted video files in the form of video clips for exchange of complex procedural information.
Next, the video clips are edited in order to provide more targeted information.

The present invention provides the user with the ability to determine input attribute such as size, quality etc. that allows for the loading of DICOM images and image runs and view and allows for edit the DICOM header in order to remove identifiable information such as the patient's name, social security number etc. The present invention provides for the ability of a single frame to be incorporated into a still image movie plus motion graphics. The present invention may provide for the ability to merge multiple images, runs into a single movie clip and may provide for measurement/annotation tools such as scale, angle arrow, circle etc. The present invention provides for basic frame layout management by removing frames from imported videos, provides for frame transition manipulation, and provides for the creation of special effects and custom watermarking. Additionally, the present invention allows for importing audio which may be placed in a timeline and recorded on the video clips. The present invention may export the generated video clips which may be compatible with AVI, WMV, FLV, MPG, MOV 3GP and may include the other commercial readily available digital file formats for video clips. The present invention may export the video clips to mobile devices such as iPad, iPhone and Android. The present invention may employ Web upload formats such as FLV, MP4, MOV and AVI. The present invention may accommodate different aspects for the video clips such as 640×480 (4:3) or 720×480 (16:9) and may accommodate a frame rate of 25 fps (frames per second) or other comparable rates. The present invention may upload the generated video clips to a free or a paid video sharing sites such as YouTube, Flickr, Picasso or Facebook or other types of sharing sites. The present invention may copy the generated video clips to Internet locations.

Video is basically a three-dimensional array of color pixels. Two dimensions serve as spatial (horizontal and vertical) directions of the moving pictures, and one dimension represents the time domain. A data frame is a set of all pixels that correspond to a single time moment. Basically, a frame is the same as a still picture.

Video data contains spatial and temporal redundancy. Similarities can thus be encoded by merely registering differences within a frame (spatial), and/or between frames (temporal). Spatial encoding is performed by taking advantage of the fact that the human eye is unable to distinguish small differences in color as easily as it can perceive changes in brightness, so that very similar areas of color can be “averaged out” in a similar way to jpeg images (JPEG image compression FAQ, part 1/2). With temporal compression only the changes from one frame to the next are encoded as often a large number of the pixels will be the same on a series of frames.

Some forms of data compression are lossless. This means that when the data is decompressed, the result is a bit-for-bit perfect match with the original.

While lossless compression of video is possible, it is rarely used, as lossy compression results in far higher compression ratios at an acceptable level of quality.

One of the most powerful techniques for compressing video is interframe compression. Interframe compression uses one or more earlier or later frames in a sequence to compress the current frame, while intraframe compression uses only the current frame, which is effectively image compression.

The most commonly used method works by comparing each frame in the video with the previous one. If the frame contains areas where nothing has moved, the system simply issues a short command that copies that part of the previous frame, bit-for-bit, into the next one. If sections of the frame move in a simple manner, the compressor emits a (slightly longer) command that tells the decompresser to shift, rotate, lighten, or darken the copy—a longer command, but still much shorter than intraframe compression. Interframe compression works well for programs that will simply be played back by the viewer, but can cause problems if the video sequence needs to be edited.

Since interframe compression copies data from one frame to another, if the original frame is simply cut out (or lost in transmission), the following frames cannot be reconstructed properly. Some video formats, such as DV, compress each frame independently using intraframe compression. Making ‘cuts’ in intraframe-compressed video is almost as easy as editing uncompressed video—one finds the beginning and ending of each frame, and simply copies bit-for-bit each frame that one wants to keep, and discards the frames one doesn't want. Another difference between intraframe and interframe compression is that with intraframe systems, each frame uses a similar amount of data. In most interframe systems, certain frames (such as “I frames” in MPEG-2) aren't allowed to copy data from other frames, and so require much more data than other frames nearby.

The present invention compresses the edited video clips and transmits the compressed edited video clips to users.

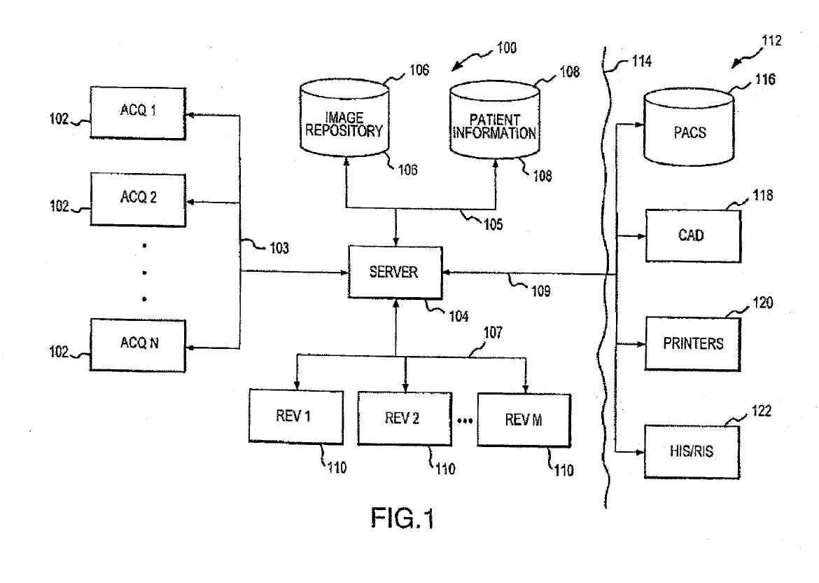

Referring first to FIG. 1, an image system 100 employing a distributed architecture is schematically illustrated. The image system 100 receives and stores video images, edits and generates video clips and compresses the video clips which may be transmitted to a remote location. The system 100 generally includes a number (n) of image acquisition stations 102 for acquiring video images, editing the video images into video clips, compressing the video clips and transmitting the video clips to the image review stations 110 and a number (m) of image review stations 110 for receiving the compressed video clips and uncompressing the compressed video clips and reviewing the video clips all of which are associated with a central server 104. It will be appreciated that the number of image acquisition stations 102 and the number of image review stations 110 that may be supported within the image system 100 is substantially unlimited and the number of image acquisition stations 102 may not be equal to the number of image review stations 110. Indeed, it is anticipated that the numbers of these stations 102 and 110 often will not be equal but will be determined and occasionally changed based on work volume and other needs. Additionally, although a single central server 104 is illustrated, it will be appreciated that the server functionality discussed below may be distributed over multiple machines or platforms.

The image acquisition stations 102 may be preferably interconnected to the server 104 by a wide bandwidth connection 103. This connection 103 may be provided as part of a Local Area Network or a Wide Area Network, e.g., a TCP/IP network. In addition, the image review stations 110 are also preferably interconnected to the server 104 by a wide bandwidth connection 107. This connection 107 may also be provided as part of a Local Area Network or Wide Area Network. In the latter regard, the illustrated system architecture allows a physician or member of the public to review images from a remote location, such as a reviewing station 110 at a physician's office separate from the medical facility that includes the acquisition stations 102, or to review images from multiple acquisition stations 102 located at different medical facilities from one another.

The illustrated server 104 may be operative to access an image repository 106 and patient information database 108, as will be discussed in more detail below. It is also operative to access a number of DICOM tools 112 via a standard DICOM interface 109. These tools 112 are schematically illustrated, as residing behind a DICOM boundary 114 associated with the interface 109, but may physically reside at a local or remote location. A variety of such DICOM tools are available. The illustrated tools 112 include a picture archiving and communication system (PACS) database 116, a computer aided design (CAD) diagnostic tool 118, printers 120 and a hospital information system (HIS)/radiology information system (RIS) 122.

The stations 102 and 110 will be described in more detail below. The image repository 106 stores image information from the image acquisition stations 102, and the patient information database 108 stores associated patient information. The illustrated repository 106 and database 108, though schematically illustrated as separate components, may be configured to form a composite searchable database structure such as a relational database system and may physically be embodied in any of various high-capacity data storage systems, such as a RAID system. That is, the images of the repository 106 are indexed to the patient information of database 108 and the patient information is organized in tables of cross-indexed data fields. Such fields may include information identifying the patient, the x-ray technique involved including dose estimates, the available images, including images from ultrasound, MRI, PET or images of pathology relating to prior or current breast biopsies, the dates of images (study), the facility where the images were acquired, the x-ray technicians involved in the image acquisition, whether the images have been reviewed, any annotations or annotated image versions, the reviewing physician, and any other information that may be of interest. This database structure may be searched by field(s) using a database management tool associated with server 104. Such tools are well known. For instance, by using such a tool a reviewer at an image review station 110 can query the database structure to obtain all images for a given patient or all such images acquired within a given date range. Alternatively, a physician may obtain all images acquired on a given date, all images for all patients acquired on a given date and associated with a particular acquisition station or stations 102, all images associated with a specific medical condition, or all images for all patients acquired on a given date and associated with an identified physician. Moreover, the search tool can be used to improve diagnosis or prognosis. In this regard, the database may be searched based in image features for a CAD annotation or other indications of the feature of interest. In this manner, similar images or image portions, or files that are otherwise of interest may be readily accessed by using the search tool.

The database structure may be used for purposes other than patient analysis. For example, the database structure may be queried by technician or acquisition site to obtain information regarding work performance or efficiency or to correct any recurring image acquisition or processing errors. The illustrated connection 105 between the server 104 and the repository 106 and database 108 may be, for example, an internal server connection (e.g., a data bus), a LAN connection or a WAN connection.

The illustrated DICOM tools 112 include a picture archiving and communication system (PACS) database 116. This database 116 is used to archive images that do not need to be kept in the repository for immediate access, but which may be desired for review. For example, a physician reviewing images for a patient may wish to review current images together with old images from a prior screening or screenings to identify any changes or signs of advancement of a condition. Such older images may be recalled from the PACS database 116 via the DICOM interface 109. Alternatively, such images may be stored, for example, on a storage device accessible at a review station 110 such as a magneto-optical (MO) drive. In either case, such archiving frees repository resources while providing flexibility for physicians to construct desired review workflows as discussed below. Moreover, the physician workflow protocols and other predictive logic of the system 100 allow the server 104 to predictively retrieve images from the repository 106 and database 116 as a background task for prompt display during a review session.

CAD tool 118 may be any of various commercially available, computer-based medical image analysis and diagnostic tools. These tools typically analyze a single image or multiple images, such as on a pixel-by-pixel basis to identify any features that may have diagnostic significance and apply diagnostic algorithms or heuristic engines to determine a possible diagnosis. In the context of mammography, such tools may identify a suspicious mass, e.g., based on a locally reduced detected signal intensity, and may further identify the possible nature of the mass (e.g., microcalcifications) based on features of the mass. Corresponding information may be annotated on the image. For example, a graphic such as a particular geometric shape (e.g., a cone or triangle) may indicate a particular potential condition and the location of the graphic on the image may indicate the location of the condition. A physician may use the graphic to zoom in on or otherwise further review the area of interest.

Such an enlarged image may be automatically retrieved or otherwise prepared for display at station 110, e.g., stored in cache at the station 110. Thus, when the physician selects the associated graphic (which may comprise a graphical user interface element superimposed on the image), an associated image may appear instantaneously. This image may be optimized based on the nature of the associated condition of interest, e.g., enlarged, contrast/brightness enhanced, edge detection enhanced, etc.

In accordance with the present invention, the CAD tool 118 can be used for preprocessing images or otherwise automatically processing images, e.g. in the background during a review session. The preprocessing of images may include the formation of video clips. The video clips a be edited to provide the user with the ability to determine input attribute such as size, quality etc. allow for the loading of DICOM images and image runs and view and edit the DICOM header in order to remove identifiable information such as the patient's name, social security number etc. The editing of the video clips provides for the ability of a single frame to be incorporated into a still image movie plus motion graphics. The editing may provide for the ability to merge multiple images, runs into a single movie clip and may provide for measurement/annotation tools such as scale, angle arrow, circle etc. The editing provides for basic frame layout management by removing frames from imported videos, provides for frame transition manipulation, and provides for the creation of special effects and custom watermarking. Additionally, the editing allows for importing audio which may be placed in a timeline and recorded on the video clips. The present invention may export video clips which may be compatible with AVI, WMV, FLV, MPG, MOV 3GP (what do the symbols stand for). The present invention may export the video clips to mobile devices such as iPad, iPhone and Android. The present invention may employ Web upload formats such as FLV, MP4, MOV and AVI. The present invention may accommodate different aspects for the video clips such as 640×480 (4:3) or 720×480 (16:9) and may accommodate a frame rate of 25 fps (frames per second) or other comparable rates. The present invention may upload to free or paid video sharing sites such as YouTube, Flickr, Picasso or Facebook or other types of sharing sites. The present invention may copy to Internet locations.
The present invention may edit to select image frames in order to include only desired frames within the video clip. The selection of the frame images may be accomplished by copy and paste.
The editing may include merging or splicing image or movie frames from two or more targeted frames to a custom frame to be in the video clip in order to create a custom frames when needed.
The editing may include the incorporation of audio or removing audio into target frames to be placed in the video clip in order to add another dimension to the video clip.
The editing may include the incorporation of text and symbolic annotations into the target frames to be placed in the video clip in order to add another dimension to the video clip.
The editing may include changing the background and layout of the target frames in order to provide a uniform video clip.
The editing may include the incorporation of frame or image transition formats to be placed in the video clip in order to provide a uniform video clip.
The editing may include incorporation of titles and/or credits within the video clip or at the end of the video clip to improve the appearance to the video clip.
The editing may include the merging of image frames and movie files to form the video clip to provide additional flexibility to generate the video clip.
The editing may include creating split screen formats for multiple movie and/or still image frames to generate the video clip in order to present related information together.
   The editing may include the direct incorporation of the image and/or movie sequences into other presentation and/or delivery formats (for eg. power-point, e-mail attachments, merged and compressed movie clips etc) in order to provide for additional flexibility and transmitting the video clips
   The editing may include creating final formats of the video clip which may be compatible with desktop, mobile, laptop, iPod, android and other formats.

In this regard, the server 104 may be programmed to automatically, upon receiving an acquired image from any of the acquisition stations 102, store one instance of the image (e.g., the raw image information) in the image repository and forward another instance or copy of the image to the CAD tool 118. This latter instance of the image may be formatted in accordance with standards of the DICOM interface 109. The image is then processed by the CAD tool 118 as discussed above and the processed image, including CAD annotations, is stored by the server 104 in the image repository 106 and indexed to the original image and corresponding patient information.

All of the noted CAD processing can occur automatically prior to the initiation of a review session by a physician. Accordingly, if desired, when the physician enters a query to gather images for a review session, the CAD-processed images may be provided from the image repository. The physician may alternatively or additionally access the raw (unprocessed) image, e.g., for comparison/confirmation purposes.

Similar CAD processing may occur during or after a review session. For example, upon an initial screening of an image, a physician may note a suspicious mass in the patient's breast. The physician may then tag the image or a location on the image for CAD processing so as to obtain the benefit of the CAD diagnostic tool. The user interface of the review station 110 may have defined keystrokes or graphical interface elements to facilitate such tagging. In response to these inputs, the processor of the review station 110 transmits the image or image portion to the server 104 which reformats the image information as necessary and forwards the information to the CAD tool 118 for analysis.

The server 104 or a processor of the review stations 110 may execute predictive algorithms, in connection with the noted CAD processing or otherwise, to anticipate the needs of the reviewing physician and improve workflow. In connection with CAD processing, the server 104 may monitor CAD processed images to anticipate such needs and automatically, as a background task, prepare enhanced images for display. For example, where a CAD annotation is included in the processed image indicating and characterizing a potential condition of interest, an enlarged view of the relevant image section with display parameters (e.g., contrast, brighteners, and enhanced edge definition) appropriate for the characterized condition may be prepared for automatic display on a monitor of the station 110 or may be stored for display upon receiving a prompt from the user. As discussed below, images may be prepared for display in a similar fashion based on protocols defined for a user, user type, review type or the like. Such protocols may also be developed or supplemental for a particular physician or on a user independent basis, using logic to monitor acquisition and review processes to empirically or heuristically learn patterns that may be used to predict physician needs.

The DICOM tools 112 also include printers 120 in the illustrated embodiment. These printers 120 receive image information via the DICOM interface 109 and provide hard copies of the images, e.g., on paper or transparencies for review on a light box or the like. This allows physicians the option of reviewing hard copy images and facilitates patient discussions in an office environment.

The HIS/RIS tool 122 provides access to HIS/RIS systems. The HIS/RIS systems include databases of patient information such as appointment dates and times and other information that may be imported into the patient information database 108 and used for populating fields of the image acquisition and image review protocols as discussed below, as well as in fashioning queries for image information. This information is readily handled by the processor 104 based on the DICOM standard. As will be appreciated by those skilled in the art, DICOM (Digital Imaging and Communications in Medicine) provides an industry standard for the exchange of digital imaging related information.

The server 104 or processors of the image review stations 110 may also execute logic for image display optimization. Such optimization may relate to optimally using the available display area for displaying the selected images (e.g. selecting a landscape, portrait, or other orientation, sizing the images, selecting zoom settings and image portions, and establishing a reference position or orientation for images to assist the physician), optimally setting display parameters (brightness, contrast, edge enhancement, etc.) or optimizing any other display-related characteristics. It will be appreciated that patient images may include imaging such as ultrasound, MRI, PET, or other molecular techniques relating to the specific patient undergoing radiologic review. Such functionality may be executed based on defined workflow protocols, CAD, or other annotations or other information available to the relevant processor(s). In this regard, optimization of a luminescence setting may be performed relative to a specific image or image portion. This may depend on a number of factors. For example, a human's ability to distinguish shades is dependent on the location of such shades within a gray scale range. That is, the ability to discern shades is not a linear function with respect to gray scale such that a given shade increment may be more readily distinguished by a viewer at a given point on the gray scale than the same increment at a different point on the gray scale. Presenting the image at an optimized luminescence may therefore enhance the viewer's ability to distinguish features of interest. So, the luminescence setting may be selected based on CAD or physician annotations indicating a condition of interest and may also take into account tissue density, source settings, exposure and other factors affecting optimal display parameters. Such display optimization may also take into consideration the size and resolution of the display as well as the display's aspect ratio including, in the case of rotatable displays as discussed below, whether the display is currently in a landscape or portrait orientation.

Additionally, special filtering may be used to optimize display parameters relative to specific areas of an image. For example, specific zoom or enlarged views of particular image areas may be provided, for example, based on a CAD annotation indicating a condition of potential interest. Moreover, the image resolution may be varied based on a feature of interest associated with a specific image area. A high resolution mode or lower resolution mode may be determined by the processing logic for an overall image, or may be selected by a user as part of a protocol definition.

As noted above, the server 104 may store multiple instances of an image in the repository 106. Such instances may include CAD-processed images and user annotated instances. A user may annotate an image to mark the image as reviewed, identify areas of interest on the image, or include other information. The annotations or markings are specifically tagged to the physician or technologist creating a record including all other relevant parameters such as date, time, location, etc. Additionally, a user may utilize the server 104 to store a user-processed image or image portion including the video clips which may have been edited as described herein that is enlarged, edge-enhanced, or otherwise modified based on user inputs. Alternatively, image modification information may be stored and indexed to an image so that modified images can be constructed as needed. Related, high resolution and lower resolution versions of an image may be used for different purposes. For example, a high resolution version may be provided to a CAD system for enhanced analysis and a lower resolution version may be provided to a review station for display so as to reduce the file size and loading times

The server 104 may also make a single image or copies of the same image available to multiple review stations 110. This may be desired for concurrent independent work or collaborative work. In the latter regard, the server 104 may include conventional collaboration logic for allowing multiple users to work on a common document and see changes entered by the other collaborator(s). Such collaboration may improve diagnosis.

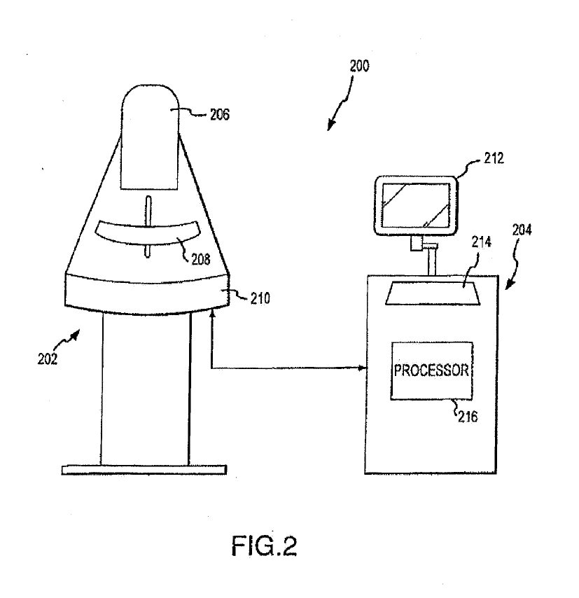

An example of an acquisition station 200 is illustrated in FIG. 2. The station 200 generally includes an imaging device 202 and a control module 204. The illustrated imaging device 202 may be an x-ray-based mammography system such as the SenoScan system marketed by Fischer Imaging Corp. of Thornton, Colo. Such imaging systems generally include an imaging source 206 such as an x-ray tube, an imaging detector 210 such as a direct x-ray detector or a phosphorescent element associated with a light detector. The illustrated device 202 further includes a compression paddle 208 that is vertically movable to immobilize and flatten, to an extent, the patient's breast for improved imaging. The paddle 208 is preferably substantially transparent to the imaging signal. In the case of the noted SenoScan system, the source 206 can be rotated to scan a fan beam of x-rays across the patient's breast. The detected x-rays are then electronically combined to form a substantially full field composite image of the patient's breast. The illustrated processing module 204 includes a user interface 214 such as a keyboard and mouse for receiving user inputs, a local monitor 212 for displaying near real-time images acquired by the device 202 and a processor 216.

FIG. 4 illustrates a flowchart diagram in accordance with the present invention. FIG. 4 illustrates in step 301 to retrieve video from the acquisition station, and in step 303 the acquisition station forms video clips from the retrieve video. In step 305, the acquisition station edits the video clips by using Dicom related procedures. In step 307, the edited video clips may be compressed and transmitted to the review station in step 309.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A video system for processing video images, comprising:
an acquisition station to review the video images and forming a video clip based upon the video images;
the acquisition station editing the video clip;
the acquisition station compressing the edited video clip;
a receiving station to receive the compressed and edited video clip.

2) A video system for processing video images as in claim 1, wherein the acquisition station edits the video clip in accordance with Dicom.

3. A video system for processing video images as in claim 2, wherein the acquisition station edits the header of the video clip.

4) A video system for processing video images as in claim 2, wherein the acquisition station merges at least two video images to be edited into a single video clip.

5) A video system for processing video images as in claim 2, wherein the acquisition station edits out a frame from the video images.

6) A video system for processing video images as in claim 2, wherein the acquisition station edits to add special effects to the video clip.

7) A video system for processing video images as in claim 1, wherein the acquisition station exports the video clip to a mobile device.

8) A video system for processing video images as in claim 1, wherein the acquisition station uploads the video clips to a paid video sharing site.

9) A video system for processing video images as in claim 1, wherein the acquisition station uploads the video clip to the Internet.

10) A method for processing video images, comprising the steps of:
reviewing the video images and forming a video clip based upon the video images;
editing the video clip;
compressing the edited video clip;
receiving the compressed and edited video clips.

11) A method for processing video images as in claim 10, wherein the method includes the step of editing the video clips in accordance with Dicom.

12. A method for processing video images as in claim 11, wherein the method includes the step of editing the header of the video clips.

13) A method for processing video images as in claim 11, wherein the method includes the step of merging at least two video images to be edited into a single video clip.

14) A method for processing video images as in claim 11, wherein the method includes the step of editing out a frame from the video images.

15) A method for processing video images as in claim 11, wherein the method includes the step of editing to add special effects to the video clip.

16) A method for processing video images as in claim 10, wherein the method includes the step of exporting the video clips to a mobile device.

17) A method for processing video images as in claim 10, wherein the method includes the step of uploading the video clips to a paid video sharing site.

18) A method for processing video images as in claim 10, wherein the method includes the step of uploading the video clips to the Internet.
